(19) United States
(12) Patent Application Publication
(10) Pub. No.: US 2024/0187535 A1
(43) Pub. Date: Jun. 6, 2024

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: TAKASHI OCHIAI, Tokyo (JP)

(21) Appl. No.: 18/496,704

(22) Filed: Oct. 27, 2023

(30) Foreign Application Priority Data
Dec. 2, 2022 (JP) 2022-193563

(51) Int. Cl. H04N 1/00

(52) U.S. Cl. CPC H04N 1/00034; H04N 1/00344

(57) ABSTRACT

An information processing apparatus includes: an inspecting unit configured to inspect a printed material based on a read image obtained by reading the printed material; a management unit configured to manage first information relating to an inspection result obtained by inspection performed by the inspecting unit; and a generating unit configured to generate data for displaying second information indicating temporal change in the inspection result.

### BACKGROUND

### Field

The present disclosure relates to processing involved with inspection of printed material.

### Description of the Related Art

An inspection apparatus that automatically inspects the quality of printed material is known. In an inspection apparatus, inspection of a printed material is performed by comparing a reference image, which serves as a reference for inspecting the printed material, with an inspection target image obtained by scanning the printed material.

In Japanese Patent Laid-Open No. 2021-187085, there is a description of displaying inspection performance on a display unit.

In Japanese Patent Laid-Open No. 2021-187085, only past inspection results similar to the contents of the currently set inspection are displayed. Therefore, with the method described in Japanese Patent Laid-Open No. 2021-187085, the user cannot verify temporal change of the inspection results.

### SUMMARY

An information processing apparatus according to the present disclosure includes: an inspecting unit configured to inspect a printed material based on a read image obtained by reading the printed material; a management unit configured to manage first information relating to an inspection result obtained by inspection performed by the inspecting unit; and a generating unit configured to generate data for displaying second information indicating temporal change in the inspection result based on the first information.

Further features of the present disclosure will become apparent from the following description of exemplary embodiments with reference to the attached drawings.

### BRIEF DESCRIPTION OF THE DRAWINGS

FIG. 1 is a block diagram illustrating an example of the configuration of a print inspection system;

FIG. 2 is a block diagram illustrating an example of the hardware configuration of a print inspection apparatus;

FIG. 3 is a block diagram illustrating the functional configuration of the print inspection apparatus;

FIG. 4A and FIG. 4B are diagrams illustrating examples of a graph representing temporal change in an inspection NG rate;

FIG. 5A and FIG. 5B are diagrams for explaining a tolerance value corresponding to an inspection NG rate;

FIG. 6A to FIG. 6D are diagrams illustrating examples of graphs representing temporal change in the inspection NG rates of multiple inspection items;

FIG. 7 is a diagram for explaining another example of a method of setting a tolerance value;

FIG. 8 is a flowchart illustrating the processing procedure of print inspection;

FIG. 9 is a diagram illustrating an example of a graph representing temporal change in an inspection NG rate;

FIG. 10 is a block diagram illustrating the functional configuration of a print inspection apparatus;

FIG. 11 is a flowchart illustrating the processing procedure of print inspection; and

FIG. 12 is a table for explaining switching of the processing according to an inspection mode.

### DESCRIPTION OF THE EMBODIMENTS

Hereinafter, explanations are given of embodiments of the technology of the present disclosure with reference to the drawings. Note that each of the following embodiments is not intended to limit the technology of the present disclosure, and every combination of the characteristics explained in each of the embodiments is not necessarily essential to the solution in the technology of the present disclosure. In addition, the technology of the present disclosure also includes a range of various forms that do not deviate from the gist of the technology of the present disclosure. Moreover, it is also possible to appropriately combine a part of each of the following embodiments.

### First Embodiment

In the first embodiment, as a method of inspecting printed material, a method of visualizing and displaying inspection results for each inspection item during inspection so that temporal change can be verified is explained. Further, a method of setting a threshold value for each inspection item and controlling the inspection level for each inspection item based on the result of comparing the inspection result and the threshold value is explained.

### <Inspection System Overview>

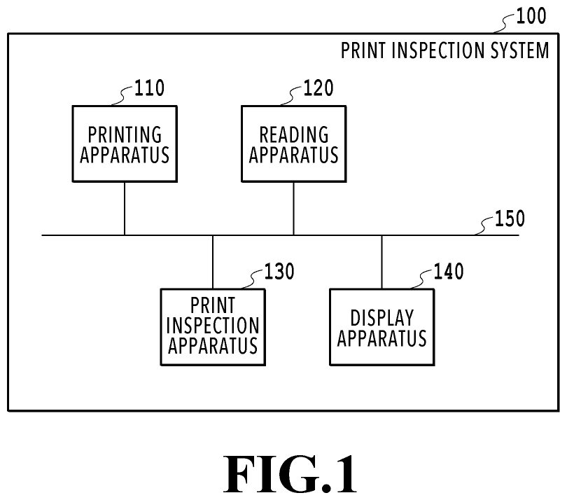

FIG. 1 is a block diagram illustrating an example of the configuration of the print inspection system 100 which performs print inspection according to the present embodiment. The print inspection system 100 includes the printing apparatus 110, the reading apparatus 120, the print inspection apparatus 130, the display apparatus 140, and the network 150 such as a LAN.

The printing apparatus 110 is an apparatus in which a printing unit with an electrophotographic system prints an image on a sheet. The printing system is not limited to the electrophotographic system, and may be another printing system such as an inkjet system.

The reading apparatus 120 is an apparatus that at least includes a reading unit such as a line sensor or a scanner, utilizes the reading unit to read a printed material, which is obtained by printing performed by the printing apparatus 110, and generates a read image of the printed material.

The print inspection apparatus 130 is an apparatus that inspects printed material obtained by printing performed by the printing apparatus 110. The print inspection apparatus 130 inspects a printed material by comparing a reference image for inspection with a read image obtained by the reading apparatus 120 reading the printed material. As a method of generating a reference image, a creation method based on RIP data or a creation method by scanning a printed material without defects can be used.

The display apparatus 140 is an apparatus that displays an operation screen for performing an inspection of printing, the state of various settings, the status of processing being executed, an inspection result, an error status, etc. The display apparatus 140 is implemented by, for example, a monitor such as a liquid crystal system.

The printing apparatus 110, the reading apparatus 120, the print inspection apparatus 130, and the display apparatus 140 are each connected via the network 150 such as a LAN, and image data, information, and various parameters are communicated among the apparatuses.

Note that, although the print inspection system 100 is explained as a configuration including the printing apparatus 110, the reading apparatus 120, the print inspection apparatus 130, and the display apparatus 140, it is not necessary that all the apparatuses exist within the same system. The print inspection system 100 may be configured with only some of the apparatuses, and an apparatus other than those may communicate with the print inspection system 100 as necessary to exchange information. Further, although the printing apparatus 110, the reading apparatus 120, the print inspection apparatus 130, and the display apparatus 140 are explained as each present as a single apparatus, it is also possible that multiple apparatuses among those included in the print inspection system 100 are implemented as one apparatus. For example, such a form in which the display apparatus 140 is incorporated as part of the print inspection apparatus 130 is also possible, and the printing apparatus 110, the reading apparatus 120, the print inspection apparatus 130, and the display apparatus 140 may be configured as one apparatus. That is, the configurations of the apparatuses are not limited.

### [Hardware Configuration]

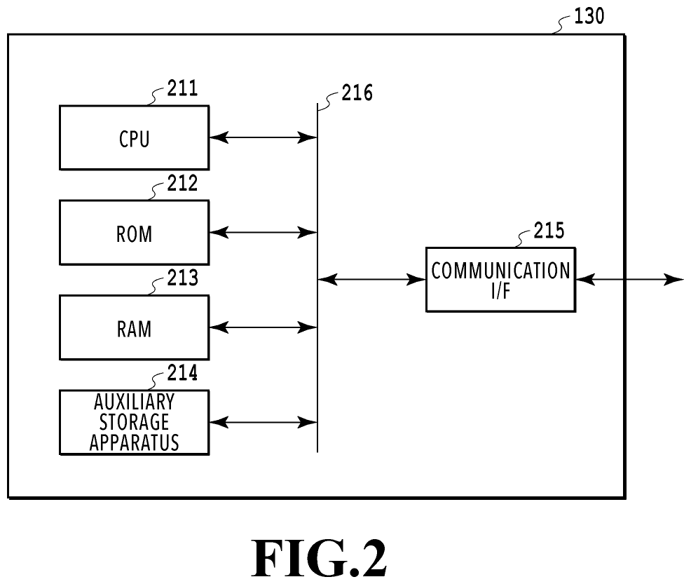

FIG. 2 is a block diagram illustrating an example of the hardware configuration of the print inspection apparatus 130. The print inspection apparatus 130 is an apparatus that also functions as an information processing apparatus, and includes the CPU 211, the ROM 212, the RAM 213, the auxiliary storage apparatus 214, the communication I/F 215, and the bus 216.

The CPU 211 implements each function of the print inspection apparatus 130 by controlling the entire print inspection apparatus 130 using a computer program and data stored in the ROM 212 or the RAM 213. Note that it is also possible to include one or multiple dedicated hardware different from the CPU 211 or to include a GPU (graphic processing unit). Further, at least a part of the processing performed by the CPU 211 may be performed by a GPU or dedicated hardware. Examples of dedicated hardware include an ASIC (Application Specific Integrated Circuit), an FPGA (Field-Programmable Gate Array), a DSP (Digital Signal Processor), etc.

The ROM 212 stores programs which do not need to be changed and the like. The RAM 213 temporarily stores a program and data supplied from the auxiliary storage apparatus 214, data supplied from the outside via the communication I/F 215, etc. The auxiliary storage apparatus 214 is configured with, for example, a hard disk drive or the like, and stores various kinds of data such as image data. The bus 216 connects each part of the apparatuses to transmit information.

The communication I/F 215 is used for communication with an external apparatus. For example, in a case of connecting to an external apparatus by wire, a cable for communication is connected to the communication I/F 215, and, in a case where there is a function for wireless communication with an external apparatus, the communication I/F 215 is equipped with an antenna.

The print inspection apparatus 130 is connected to an input apparatus, such as a keyboard, a mouse, etc., via the communication I/F 215. The communication I/F 215 accepts various user instructions that are input using the input apparatus, such as inputting values in various settings, selection of various buttons, etc.

Further, the print inspection apparatus 130 is connected to the display apparatus 140 via the communication I/F 215. The CPU 211 causes the display apparatus 140 to display, via the communication I/F 215, various operation screens related to inspection and various display screens, such as for an inspection result. The CPU 211 also functions as a display control unit that controls the screens displayed on the display apparatus 140. Note that the display apparatus 140 and the input apparatus may be an integrated apparatus, and the display apparatus 140 and the input apparatus may be implemented as a mobile terminal such as a smart phone or a tablet.

The functions of the print inspection apparatus 130 are implemented according to the hardware configuration of FIG. 2. Further, the processing flow and algorithm in the print inspection apparatus 130 operate on a PC (personal computer), a dedicated computing machine, an internal built-in circuit, or the like. That is, each of the functional and the other units, methods, and algorithm explained in the present embodiment is implemented by software or hardware. A calculation apparatus such as the above-described CPU or GPU performs calculations for each unit, and data to be used is read and written using a memory such as the RAM or ROM, or a large-capacity storage HDD. Although the hardware configuration of the print inspection apparatus 130 is shown in FIG. 2, it is assumed that other apparatuses constituting the print inspection system 100 also have the same configuration as that shown in FIG. 2. Furthermore, every function in each apparatus is implemented under the control of a computer.

### [Functional Configuration]

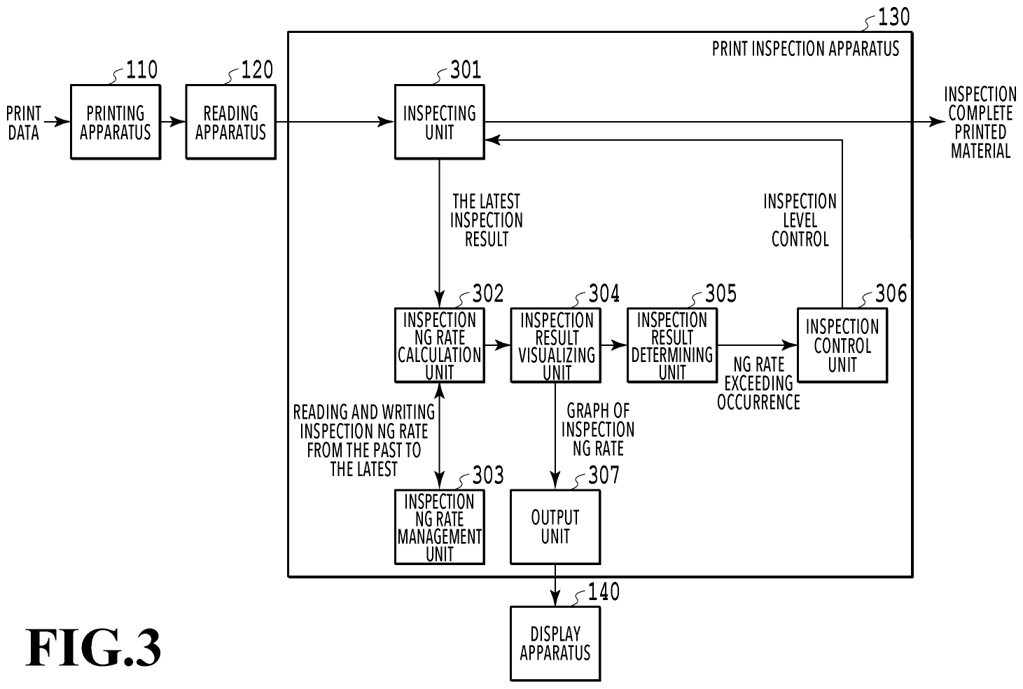

FIG. 3 is a block diagram illustrating each function of the print inspection apparatus 130. The print inspection apparatus 130 includes the inspecting unit 301, the inspection NG rate calculation unit 302, the inspection NG rate management unit 303, the inspection result visualizing unit 304, the inspection result determining unit 305, the inspection control unit 306, and the output unit 307.

The inspecting unit 301 obtains a read image, which is obtained by the reading apparatus 120 reading a printed material targeted for inspection, as an image of the printed material targeted for inspection. The printed material targeted for inspection is printed material obtained as a result of printing performed by the printing unit of the printing apparatus 110. The read image is, for example, an image generated by the reading unit of the reading apparatus 120 reading a printed material targeted for inspection at a reading resolution of 600 dpi.

In a case where multiple inspection items are set, the inspecting unit 301 performs an inspection of each of the multiple inspection items. Inspection items include, for example, inspection items related to image quality defects, such as streaks and spots, and inspection items other than image quality defects, such as print position misalignment and sheet corner folds. The inspecting unit 301 determines either “inspection OK” (inspection passed) or “inspection NG” (inspection failed) for each inspection item, and outputs the determined result.

Alternatively, the inspecting unit 301 may be configured to output inspection OK as the inspection result of the printed material targeted for inspection only in a case where none of the inspection items is determined to be NG regarding the read image of the printed material targeted for inspection, and output inspection NG if there is even one NG among the inspection items.

The inspecting unit 301 compares the read image of a printed material targeted for inspection with a reference image to determine either inspection OK or inspection NG. The reference image is an image generated in advance by reading multiple defect-free printed materials with the same pattern as the printed material targeted for inspection, and combining the multiple images obtained as a result of the reading. Alternatively, the reference image may be generated from RIP data or the like used in printing to obtain the printed material targeted for inspection.

The inspection NG rate calculation unit 302 receives the result of inspection determined by the inspecting unit 301 as either inspection OK or inspection NG, and calculates the inspection NG rate as information representing the inspection result. The inspection NG rate is a value indicating the ratio of the number of past inspections determined as inspection NG to the number of past inspections at the time of calculation. The inspection NG rate calculation unit 302 manages the total number of past inspections and the number of inspections determined as inspection NG in the past inspections for each inspection item, and the inspection NG rate calculation unit 302 calculates the inspection NG rate for each inspection item.

For example, with respect to the streak inspection item, assume that the inspecting unit 301 determines one of 100 printed materials inspected as inspection NG. In this case, the inspection NG rate calculation unit 302 calculates the inspection NG rate of the streak inspection as 1%. Alternatively, the inspecting unit 301 may output inspection NG as the inspection result corresponding to a printed material in a case where NG is determined for any of the inspection items as a result of performing the inspection of each inspection item on the printed material targeted for inspection. In this case, the inspection NG rate calculation unit 302 calculates the inspection NG rate to be 0.5% in a case where only one printed material of 200 printed materials inspected is determined to be NG for some inspection item.

In a case of calculating the inspection NG rate, the inspection NG rate calculation unit 302 may calculate the inspection NG rate using various values, such as the total number of areas for inspection or the total number of inspection items for inspection, as a parameter other than the total number of past inspections.

The inspection NG rate management unit 303 obtains the inspection NG rate calculated by the inspection NG rate calculation unit 302 each time, and stores the inspection NG rate in a storage unit such as the auxiliary storage apparatus 214 in association with the inspection number at the time of calculation. In this way, the inspection NG rate management unit 303 stores data related to the inspection NG rate from the past, going back a predetermined time period from the latest inspection number, to the latest, and manages the change of the inspection NG rate in chronological order.

The inspection result visualizing unit 304 is a generating unit which generates data for visualizing temporal change of the inspection NG rate using information on the change of the inspection NG rate from the past to the latest managed by the inspection NG rate management unit 303. Specifically, data is created so that the display apparatus 140 displays a screen of a graph representing temporal change of the inspection NG rate.

Each time the inspection result visualizing unit 304 generates data, the output unit 307 outputs the generated data to the display apparatus 140 to display a graph representing temporal change of the inspection NG rate. The display apparatus 140 receives the graph of the inspection NG rate created by the inspection result visualizing unit 304 and displays the graph on the screen. In this way, by displaying temporal change of the inspection NG rate in a graph, the user can grasp the temporal change of the inspection result for each inspection item in real time even during the inspection. An example of the graph representing temporal change of the inspection NG rate is described hereinafter.

The inspection result determining unit 305 determines whether the calculated inspection NG rate exceeds the tolerance value. Details are described hereinafter.

The inspection control unit 306 performs a control so that the inspection level of the inspection performed by the inspecting unit 301 is changed in a case where the inspection NG rate satisfies a predetermined condition. For example, the inspection control unit 306 relaxes the inspection level (lowers the inspection level) so that the inspecting unit 301 can easily determine inspection OK.

The inspection level represents the detection accuracy of defects such as streaks and print misalignment. For example, there may be a configuration where the inspection level can be set with multiple stages for each inspection item. In this case, the inspection control unit 306 can change the inspection level to be more relaxed by changing the value indicating the stage of the inspection level.

Alternatively, the inspection control unit 306 may control the inspection level by changing the parameters used for inspection of each inspection item. For example, in the case of an inspection item for streaks, an image processing filter (LoG filter (Laplacian of Gaussian Filter)) utilized to emphasize the streak width to be detected is used. By adjusting the set value of the image processing filter, the inspection control unit 306 can control the inspection level of the inspection item for streaks to be relaxed. Further, in an inspection regarding an inspection item for print position misalignment, in a case where the amount of misalignment between the reference image and the read image targeted for inspection is equal to or greater than the threshold value, the determination is inspection NG. By adjusting this threshold value, the inspection control unit 306 can control the inspection level of the inspection item for print misalignment to be relaxed.

As described above, in the present embodiment, the inspection level of an inspection item is controlled according to change in the inspection NG rate during the inspection. By controlling in this way, the print inspection apparatus 130 can continue inspection with no need to end the inspection in the middle of the inspection.

Although each functional unit included in the print inspection apparatus 130 is implemented by the CPU 211 executing a predetermined program, there is not a limitation as such. In addition, for example, hardware such as a GPU (Graphics Processing Unit) or FPGA (Field Programmable Gate Array) for speeding up calculation may be utilized. Each functional unit may be implemented through cooperation of software and hardware such as a dedicated IC, or a part or all of the functions may be implemented by hardware alone. Further, although the print inspection apparatus 130 is explained as a single apparatus in the present embodiment, the same hardware configuration implemented in any apparatus of the print inspection system 100 may also be used to implement any functional unit included in the print inspection apparatus 130.

[Display Example of Graphs of Inspection NG Rate Change (in a Case where there is One Inspection Item)]

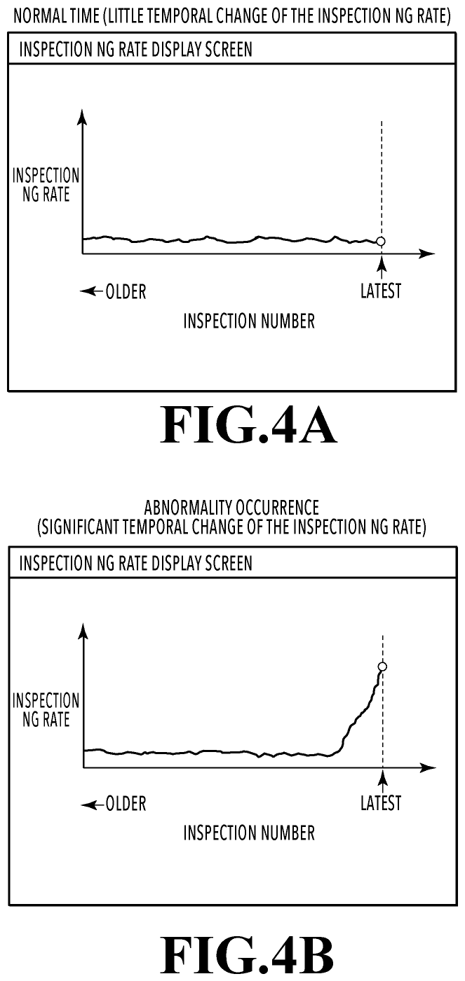

FIG. 4A and FIG. 4B are diagrams illustrating examples of information representing temporal change of the inspection NG rate of a certain inspection item, which is generated by the inspection result visualizing unit 304. The horizontal axis of the graphs in FIG. 4A and FIG. 4B represents inspection number. The inspection number is a unique value that is serially assigned to each inspection, with a smaller value of the inspection number indicating an older inspection than a larger value. The graphs of FIG. 4A and FIG. 4B show the further to the right side of the horizontal axis, the inspection is more recent with later inspection execution date and time. The vertical axis of the graphs indicates inspection NG rate corresponding to inspection number. The inspection NG rate corresponding to the inspection number is the ratio of the number of inspection NG determinations to the number of inspections executed in the past at the time the inspection indicated by the inspection number is executed.

FIG. 4A is an example of a graph of a normal case in which there is little temporal change of the inspection NG rate. From the graph in FIG. 4A, it can be confirmed that, even near the latest inspection number, the inspection NG rate has changed little from the past, and the inspection NG rate has not changed significantly from the past.

FIG. 4B is an example of a graph of a case where the temporal change of the inspection NG rate is significant and an abnormality has occurred. In FIG. 4B, it can be confirmed that the inspection NG rate has significantly changed compared to the past near the latest inspection number. In this way, the change in the inspection NG rate during the inspection differs between a case where an abnormality has not occurred (a normal case) and a case where an abnormality has occurred. Once the latest inspection result is obtained by the inspecting unit 301, the inspection NG rate at the time of the inspection is calculated. Furthermore, each time the inspection NG rate is calculated, the inspection result visualizing unit 304 generates a graph of up to the latest inspection number, and the graph is displayed on the display apparatus 140. Alternatively, the graph may be displayed on the display apparatus 140 so that the graph is updated every predetermined time period. Alternatively, the inspection NG rate may be updated after each predetermined time has elapsed.

[Method for Determining Abnormality in Inspection NG Rate (in a Case where there is One Inspection Item)]

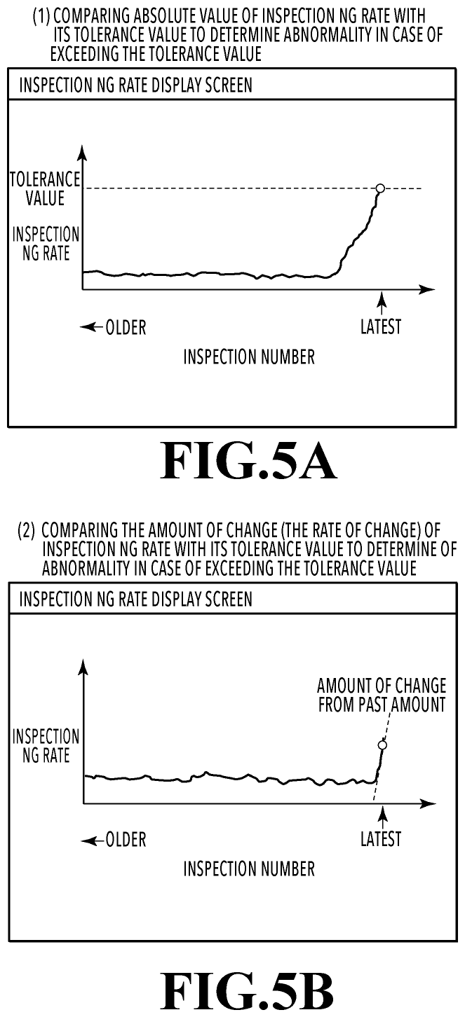

FIG. 5A and FIG. 5B are diagrams for explaining the method for how the inspection result determining unit 305 decides whether an abnormality has occurred using the calculated inspection NG rate. In FIG. 5A and FIG. 5B, graphs representing the change of the inspection NG rate in a case where there is one inspection item, and the tolerance values for that inspection item, are illustrated.

The inspection result determining unit 305 determines whether the absolute value of the inspection NG rate exceeds the tolerance value. The tolerance value is set in advance for each inspection item for which the inspection NG rate is calculated, or for each sheet. As illustrated in FIG. 5A, a case where the inspection NG rate exceeds the tolerance value is referred to as abnormal. A state in which the inspection NG rate is higher than the tolerance value indicates a status in which the yield rate (productivity) is poor. On the other hand, a case where the inspection NG rate is below the tolerance value is referred to as normal. Although the inspection result determining unit 305 determines whether the inspection NG rate exceeds the tolerance value in the explanation of the present embodiment, it is also possible that the inspection result determining unit 305 determines whether other values exceed a tolerance value.

For example, as illustrated in FIG. 5B, the inspection result determining unit 305 may determine whether the amount of change (the rate of change) in the inspection NG rate exceeds a tolerance value. In this case, a case where the amount of change in the inspection NG rate exceeds the tolerance value is referred to as abnormal, and a case where the amount of change in the inspection NG rate is below the tolerance value is referred to as normal. Similar to the tolerance value in the case of FIG. 5A, the tolerance value in FIG. 5B is set in advance for each inspection item for which the inspection NG rate is calculated or for each sheet.

Alternatively, the inspection result determining unit 305 may determine whether the change in the inspection NG rate is abnormal using both the absolute value of the inspection NG rate and the amount of change (the rate of change) of the inspection NG rate. Alternatively, in order to eliminate the influence of small fluctuations in the inspection NG rate, whether an abnormality has occurred may be determined by using data obtained by applying processing such as moving average to the inspection NG rate. Further, instead of the inspection NG rate, the number of inspection NGs or the amount of change in the number of inspection NGs may be compared with a tolerance value to determine either abnormal or normal.

[Display Example of Graphs of Inspection NG Rates (in a Case where there are Two Inspection Items)]

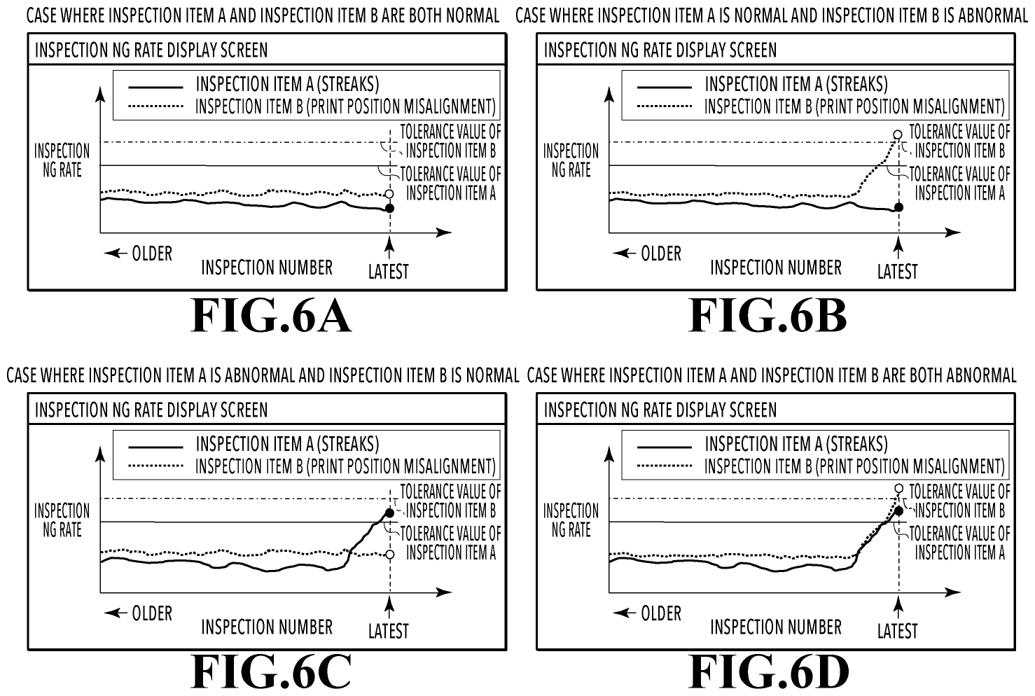

FIG. 6A to FIG. 6D are diagrams illustrating an example of graphs, which are generated by the inspection result visualizing unit 304 and represent temporal change of the inspection NG rates of multiple inspection items. In FIG. 6A to FIG. 6D, an example of graphs of the inspection NG rates in cases where there are two inspection items, i.e., inspection item A and inspection item B, is illustrated. For example, the inspection item A is an inspection for occurrence of streaks (a streak inspection), and the inspection item B is an inspection for occurrence of print position misalignment (a print position misalignment inspection). It is assumed that the tolerance values for the different inspection NG rates are set for the inspection item A and the inspection item B.

FIG. 6A shows an example of a graph in a case where both the inspection NG rate of inspection item A and the inspection NG rate of inspection item B are below the respective tolerance values at the time of the latest inspection. FIG. 6B is an example of a graph in a case where the inspection NG rate of inspection item A is below the tolerance value and the inspection NG rate of inspection item B exceeds the tolerance value at the time of the latest inspection.

FIG. 6C is an example of a graph in a case where the inspection NG rate of inspection item B is below the tolerance value and the inspection NG rate of inspection item A exceeds the tolerance value at the time of the latest inspection. FIG. 6D shows an example of a graph in a case where both the inspection NG rate of inspection item A and the inspection NG rate of inspection item B exceed the respective tolerance values at the time of the latest inspection. In this way, it is also possible to generate a graph of the inspection NG rate for each inspection item to be displayed for the user.

### [Tolerance Value of Inspection NG Rate]

In a case where there are multiple inspection items, a different value may be set for each inspection item as the tolerance value of the inspection NG rate. Furthermore, the inspection result determining unit 305 determines whether or not the tolerance value is exceeded for each inspection item, thereby deciding whether an abnormality has occurred in the inspection for each inspection item. For example, the tolerance values for inspection items related to image quality defects such as streaks and spots, which are relatively highly important inspection items, may be lower than the tolerance values for inspection items not related to image quality defects such as print misalignment. By setting the tolerance values of important inspection items to be low in the display, in a case where the NG rates of the important inspection items become high, the user's attention can be prompted early. By setting the tolerance values in this way, it is possible to display the inspection results with an emphasis on the items that directly contribute to the image quality.

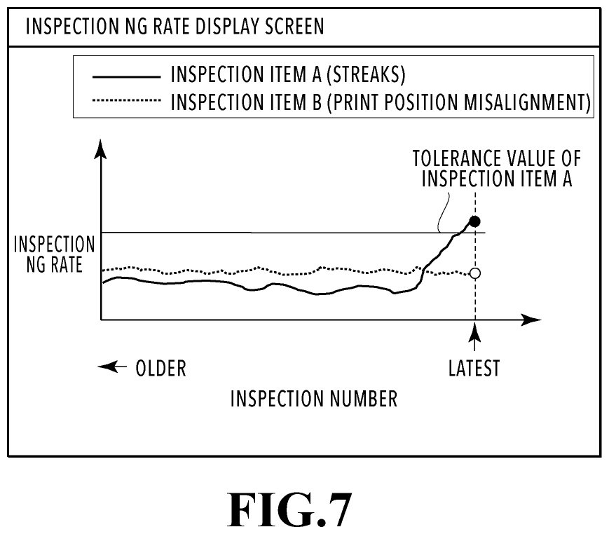

FIG. 7 is a diagram for explaining another example of how to set a tolerance value. For example, setting tolerance values only for inspection items related to image quality defects, such as streaks, without setting tolerance values for the inspection NG rates of inspection items that are not related to image quality defects, such as print position misalignment, is also possible. Even in that case, as illustrated in FIG. 7, regardless of whether or not the tolerance value is set, a graph representing the temporal change of the inspection NG rate of each inspection item may be generated and displayed on the display apparatus as well. That is, the inspection control unit 306 may be configured not to control the inspection level of inspection items for which the tolerance value is not set.

### [Processing Procedure of Print Inspection]

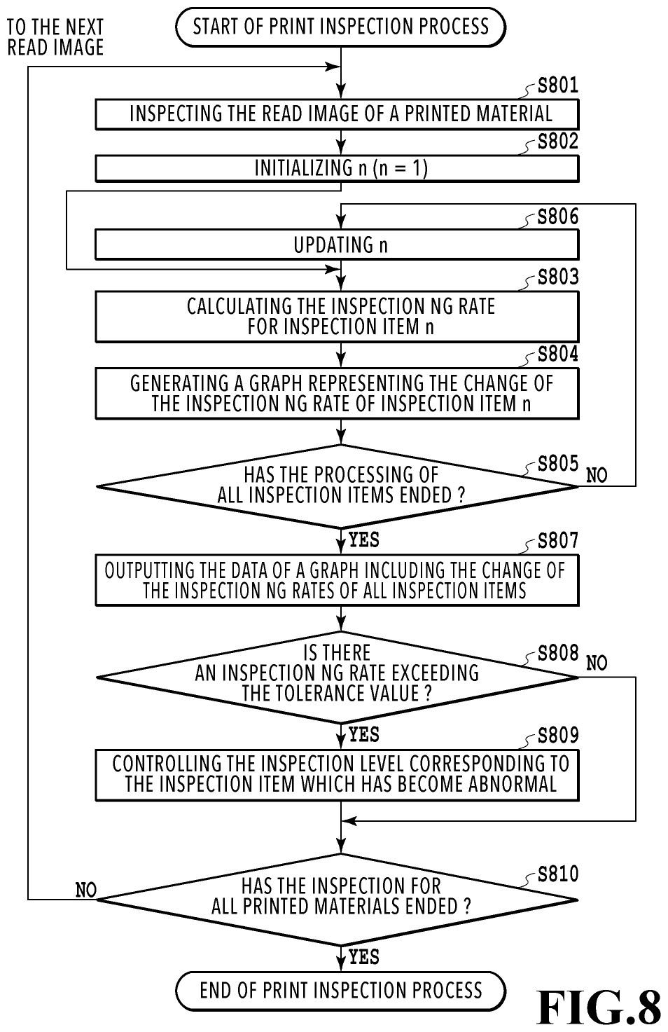

FIG. 8 is a flowchart illustrating the processing procedure of a print inspection in the print inspection apparatus 130. The series of processes illustrated in the flowchart of FIG. 8 is implemented by the CPU 211 reading and loading a control program stored in the ROM 212, the auxiliary storage apparatus 214, or the like into the RAM 213 and executing the control program. The explanation hereinafter is made according to the flowchart in FIG. 8. Note that the symbol “S” indicates a step. The flowchart in FIG. 8 is started after the print inspection process is started.

In S801, the inspecting unit 301 obtains the read image of the printed material targeted for inspection at the time, and uses the read image to perform an inspection of an inspection item. In a case where there are multiple inspection items, for example, the first inspection item 1 is set to be a streak inspection, the second inspection item 2 is set to be a print position misalignment inspection, and, in S801, an inspection is performed for each inspection item. The number of inspection items may be one.

In S802, the inspection NG rate calculation unit 302 initializes n, which is a number for identifying an inspection item. For example, n=1 is set as the initial value. The initial value of n is set in the present step since the processing on the n-th inspection item n is performed in the next steps S803 and S804.

In S803, the inspection NG rate calculation unit 302 performs calculation of the inspection NG rate of the n-th inspection item n targeted for processing. Specifically, in a case where the current inspection is determined as inspection NG, the inspection NG rate calculation unit 302 adds the result of the current inspection to the number of past inspections for the inspection item n determined as inspection NG, and calculates the ratio of the number of inspection NG determinations to the total number of inspections for inspection item n.

The inspection NG rate management unit 303 stores the calculated inspection NG rate in a storage unit such as the auxiliary storage apparatus 214 in association with the inspection number of the inspection executed in the immediately prior step S801.

In S804, the inspection result visualizing unit 304 obtains the inspection NG rates calculated at the times of past inspections for the inspection item n from the inspection NG rate management unit 303, and generates a graph representing temporal change of the inspection NG rates of the n-th inspection item n from the past to the current inspection. In a case where there are multiple inspection items and the graph of another inspection item has already been generated, the graph of the processing target inspection item n is added as illustrated in FIG. 6A to FIG. 6D.

In S805, the inspection result visualizing unit 304 determines whether a graph of the inspection NG rate has been generated for all inspection items. In a case where generation of a graph for all inspection items has not ended (NO in S805), in S806, a value obtained by adding 1 to the current n is set as the new n by the inspection result visualizing unit 304 in order to update n. Thereafter, the processing returns to S803. In the next steps S803 to S804, processing is performed for the new inspection item n. On the other hand, in a case where generation of a graph for all inspection items has ended (YES in S805), the processing proceeds to S807.

In S807, the output unit 307 outputs data for displaying the graphs generated by the inspection result visualizing unit 304 in order to cause the display unit of the display apparatus 140 to display a graph representing temporal change of the inspection NG rates of all inspection items. As a result, the graphs generated by repeating S803 to S804 is displayed on the display unit of the display apparatus 140.

In S808, the inspection result determining unit 305 determines whether the latest inspection NG rate calculated in S803 exceeds the tolerance value for each inspection item for which the tolerance value is set. That is, whether or not there is an inspection item for which an abnormality has occurred in the inspection NG rate is determined. In a case where there is an inspection item whose inspection NG rate exceeds the tolerance value (YES in S808), the processing proceeds to S809.

In S809, the inspection control unit 306 performs a control on the inspection level corresponding to the inspection item whose inspection NG rate exceeds the tolerance value. For example, as described above, the inspection level of an inspection item whose inspection NG rate exceeds the tolerance value is controlled to be relaxed so that the frequency of inspection NG determinations is reduced. Thereafter, the processing proceeds to S810. In a case where there is no inspection item whose inspection NG rate exceeds the tolerance value (NO in S808), S809 is skipped and the processing proceeds to S810.

As an example of the reason why an inspection NG rate exceeds the tolerance value and becomes abnormal, there are many temporary reasons such as the adhesion of dust to the printing unit of the printing apparatus 110 or the reading unit of the reading apparatus 120. If the reason why an inspection NG rate exceeds the tolerance value is a temporary reason, it may be preferable to continue printing and inspection because the abnormality may be resolved in the process of printing and inspection. On the other hand, in a case where the printing apparatus 110 prints a predetermined number of printed materials, the printing is performed until the number of printed materials determined as inspection OK reaches the predetermined number. Thus, if printing is continued while maintaining the conventional inspection level even though an inspection NG rate exceeds the tolerance value, a large amount of inspection NG printed materials that are not counted in the number of copies will continue to be printed. Therefore, in the present embodiment, in a case where an inspection NG rate exceeds the tolerance value, the inspection level is relaxed and the inspection is performed. Further, by continuing printing in the printing apparatus 110, it is possible to suppress a decrease in the productivity of printed material with inspection OK.

In S810, the inspecting unit 301 determines whether the inspection of all printed materials has ended. In a case where there are printed materials that have not been inspected, that is, in a case where inspection of all printed materials has not ended (NO in S810), the processing returns to S801. Then, in S801, the read image of the next printed material targeted for inspection is obtained, and the processing of S802 to S809 is repeated. On the other hand, in a case where the inspection of all printed materials has ended (YES in S810), the print inspection process ends.

[Countermeasure for the Period where the Parameter for Calculating the Inspection NG Rate is Small]

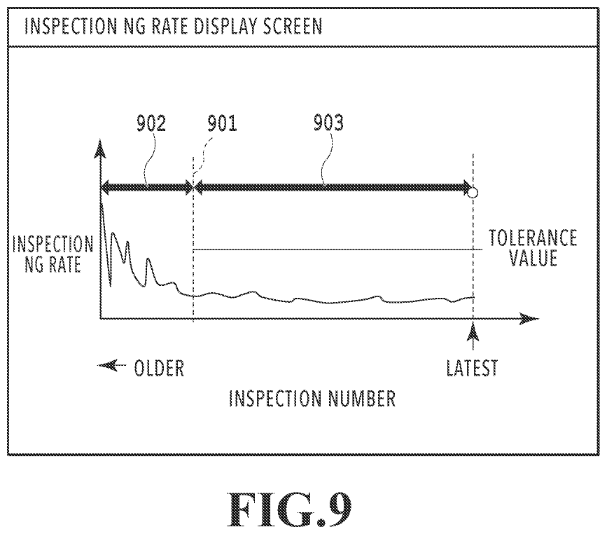

FIG. 9 is a diagram illustrating an example of a graph representing temporal change of the inspection NG rate in a case where the number of inspections, which is a parameter for calculating the inspection NG rate, is small. The parameter for calculating the inspection NG rate is the total number of inspections that the inspecting unit 301 has executed so far, and the calculation of the inspection NG rate is such that the older the inspection number, the smaller the parameter, and the newer the inspection number, the larger the parameter.

In FIG. 9, with the boundary 901 as a border, there are the section 902 where the inspection NG rate changes significantly and the section 903 where the inspection NG rate does not change significantly. As in the section 902, the older the inspection number, that is, the smaller the parameter for calculating the inspection NG rate, the greater the tendency of the inspection NG rate to fluctuate. For example, as an extreme case, in a case where an inspection NG occurs in the first inspection, according to the calculation, the inspection NG rate is calculated as 100%.

On the other hand, as in the section 903 in FIG. 9, the inspection NG rate tends to stabilize gradually as the inspection number is newer, that is, as the number of inspections increases. The inspection NG rates in the graphs of FIG. 4A and FIG. 4B represent the temporal changes of the inspection NG rates after the inspection has been performed a sufficient number of times. As the number of inspections increases, variations in the change in the inspection NG rates are suppressed.

The graph of the inspection NG rate generated by the inspection result visualizing unit 304 shows temporal change, and is for showing the user how the inspection NG rate is changing in a case where inspection of multiple printed materials is continuously executed. Further, the control of the inspection level is a process of changing the inspection level in an event that an abnormality has occurred in the case where the inspection of multiple printed materials is continuously executed. Therefore, the inspection result visualizing unit 304 may generate a graph excluding the inspection NG rate while the number of inspections is small. Further, the inspection result determining unit 305 may not perform a determination of whether the inspection NG rate exceeds the tolerance value while the number of inspections is small.

For example, the minimum number of inspections for calculating the inspection NG rate is set to 10 times (10 printed materials). Until the minimum number of times is reached, the inspection NG rate calculation unit 302 need not calculate the inspection NG rate. Further, the graph showing temporal change of the inspection NG rate need not be generated. Alternatively, even in a case of calculating the inspection NG rate and displaying the graph, the inspection result determining unit 305 need not determine whether the inspection NG rate exceeds the tolerance value. That is, it is possible to perform processing without controlling the inspection level. The minimum number of times is not limited to 10, and may be appropriately set or changed depending on the number of prints, the inspection level, the state of the printing apparatus 110, etc.

Note that, in a case of calculating the inspection NG rate, the inspection NG rate calculation unit 302 need not use the number of all past inspections as a parameter to calculate the inspection NG rate. For example, in S803, the inspection NG rate calculation unit 302 obtains the number of inspection NG determinations in inspections going back 100 times from the current inspection. Then, the inspection NG rate may be calculated by calculating the number of inspection NG determinations relative to the number of inspections being 100. In this way, on the occasion of calculating the inspection NG rate, the inspection NG rate may be calculated for each fixed number of inspections. Alternatively, the inspection NG rate may be calculated by thinning out the determination result of some inspections. Alternatively, the inspection NG rate may be calculated using a statistic such as moving average so as to eliminate obtaining an excessive inspection NG rate.

As explained above, in the present embodiment, temporal change of an inspection NG rate during inspection can be visualized for each inspection item and presented to the user. Thereby, the user can grasp the change of the inspection result for each inspection item in real time during the inspection.

Further, according to the present embodiment, it is possible to set a tolerance value for each inspection item and control the inspection level for each inspection item based on the result from comparing the tolerance value with the inspection result. In this way, in a case where the inspection status changes during inspection, it is possible to continue inspection and printing by performing a control such as lowering the inspection level. Therefore, suppressing a decrease in the productivity of printed material in the printing apparatus is possible.

Note that, although the examples in which the graph of an inspection NG rate is displayed on the display apparatus 140 are shown in the explanation above, the display destination of the graph is not limited to the display apparatus 140. As an alternative, it is also possible to use such a method in which the output unit 307 outputs data for displaying the graph to a printing apparatus and the printing apparatus prints the graph showing temporal change of the inspection result to present the graph to the user as an inspection report or the like.

Further, the method of visualizing temporal change of the inspection result, such as the inspection NG rate, is not limited to such line graphs shown in FIG. 4A and FIG. 4B, etc. Alternatively, for example, a bar graph, a discrete point graph, etc., may be used. Furthermore, showing in the form of a graph is not necessary as long as temporal change of the inspection result is visualized. For example, there is no problem if the change of the inspection NG rate is represented in a tabular format.

Further, in a case where there are multiple inspection items, the inspection NG rates of multiple inspection items may be displayed together in one graph as in FIG. 6A to FIG. 6D, or it is also possible to create a graph for each inspection item, so as to display the graph of each inspection item. In this case, a graph for every single inspection item may be generated, or it is also possible that multiple inspection items are grouped into multiple groups to generate a graph for each of the multiple groups.

Further, in a case where an inspection NG rate exceeds the tolerance value, a process of notifying the user that the tolerance value has been exceeded may be performed. For example, processing such as coloring the line on the graph showing the inspection result of the applicable inspection item, notifying with a dialog box, notifying to a mobile terminal, etc., may be performed.

Further, an abnormality detection button may be installed on the screen displaying information on the temporal change of the inspection NG rate. Furthermore, there may also be a configuration in which a user who is visually checking the graph of change of the inspection NG rate can manually change the inspection level by pressing the abnormality detection button on the same screen.

Further, in a case where the inspection level is controlled to be relaxed to make an inspection OK determination easier because the inspection NG rate exceeded the tolerance value, the printing apparatus 110 can be controlled to change the sheet discharge destination of the printed material determined as inspection OK from the one used before relaxing the inspection level. By changing the sheet discharge destination, it is possible to separately manage printed materials inspected at different inspection levels. Further, in a case where the inspection level is changed to a more relaxed inspection level while printing multiple pages of printed material, the printing apparatus 110 can be controlled to discard the pages printed before the change in the inspection level. Furthermore, the printing apparatus 110 may reprint the discarded printed material from the first page, so that all pages included in one copy of the printed material are inspected at the same inspection level. In this way, inspection of one copy of printed material with a unified inspection mode is possible.

In the explanation above, as an example, it is assumed that the inspection result presented to the user during the inspection is described as the inspection NG rate. The inspection result, which corresponds to the value on the vertical axis of the graph, may be information other than the inspection NG rate as long as it is capable of expressing the tendency of inspection performed by the inspecting unit 301 during the inspection. For example, the inspection OK rate indicating the ratio of inspection OKs to the number of inspections, the number of inspections NGs, the number of inspection OKs, etc., can be used as the value on the vertical axis of the graph.

In S808 of FIG. 8, the explanation is given of the method in which the inspection result determining unit 305 determines whether the inspection NG rate exceeds the tolerance value, so that the processing is switched according to the determination result. As an alternative, it is also possible to set a threshold value different from the tolerance value, so that, in S808, the inspection result determining unit 305 determines whether the inspection NG rate exceeds the threshold value. If YES is determined in S808, the inspection level is adjusted to be more relaxed. It is conceivable that, if the inspection level is relaxed, the quality of the printed material related to the inspection item will be degraded. Therefore, the determination in S808 may be performed with the threshold value set higher for an important inspection item than for an unimportant inspection item.

Further, the control of the inspection level may be performed in multiple stages. That is, multiple threshold values (tolerance values) may be set for one inspection item. For example, it is also possible that a first threshold value and a second threshold value greater than the first threshold value are set, and, if the inspection NG rate exceeds the second threshold value, the inspection level is controlled to be even more relaxed than a case in which the first threshold value is exceeded.

### Second Embodiment

In the first embodiment, the explanation is given of the method for continuing the inspection and printing by relaxing the inspection level in a case where the value indicating the inspection result during the inspection exceeds the tolerance value. Depending on the printed material, it is conceivable that continuing the inspection while maintaining a desired inspection level without relaxing the inspection level is required. Therefore, in the present embodiment, an explanation is given of the print inspection apparatus 130 that is capable of setting an inspection end mode for ending the inspection and printing in a case where a value indicating the inspection result exceeds the tolerance value during inspection. Regarding the present embodiment, the differences from the first embodiment are mainly explained. The parts that are not particularly described have the same configurations or processes as those of the first embodiment.

### [Functional Configuration of Print Inspection Apparatus]

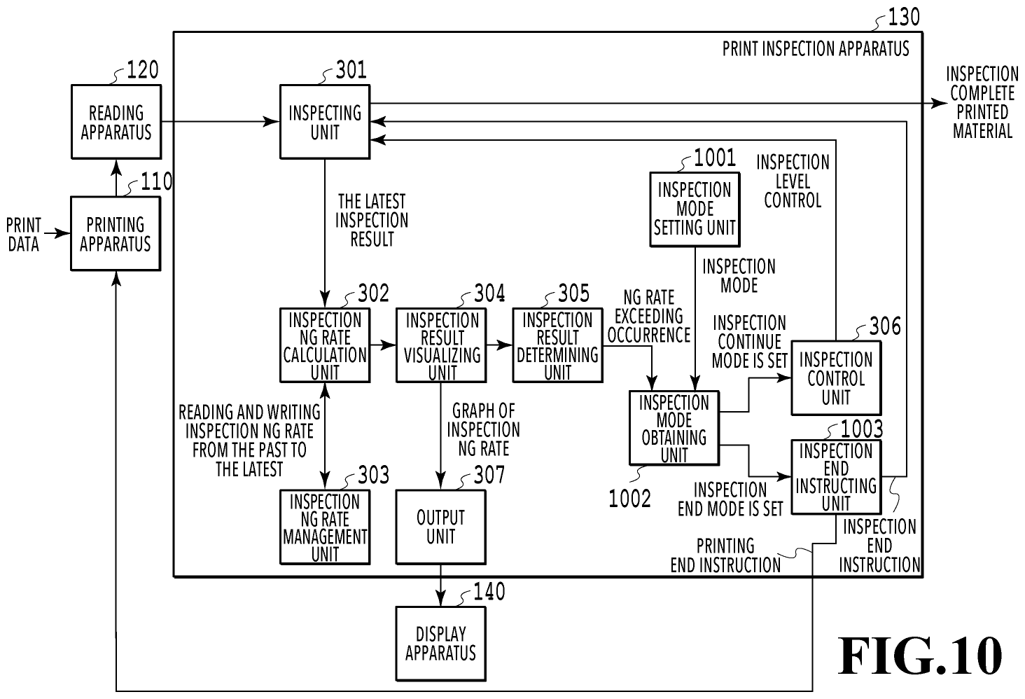

FIG. 10 is a block diagram for explaining the functions of the print inspection apparatus 130 of the present embodiment. The same configurations as those of the first embodiment are noted with the same reference signs to omit explanations thereof. The print inspection apparatus 130 of the present embodiment has the inspection mode setting unit 1001, the inspection mode obtaining unit 1002, and the inspection end instructing unit 1003 in addition to the functional units explained in the first embodiment.

The print inspection apparatus 130 of the present embodiment is configured to be able to set either the inspection end mode or the inspection continue mode as the inspection mode. The inspection end mode is a mode for ending the inspection and printing in a case where an inspection NG rate during inspection exceeds the tolerance value. The inspection continue mode is a mode in which the inspection and printing are continued even in a case where an inspection NG rate during inspection exceeds the tolerance value.

The inspection mode setting unit 1001 presets the inspection mode to either the inspection end mode or the inspection continue mode. For example, the inspection mode selected by the user is set. The inspection mode set by the inspection mode setting unit 1001 is stored in the RAM 213 or the auxiliary storage apparatus 214.

The inspection mode obtaining unit 1002 obtains the inspection mode set by the inspection mode setting unit 1001. The inspection end instructing unit 1003 instructs the printing apparatus 110 to end printing in a case where the inspection end mode is set as the inspection mode.

### [Processing Procedure of Print Inspection]

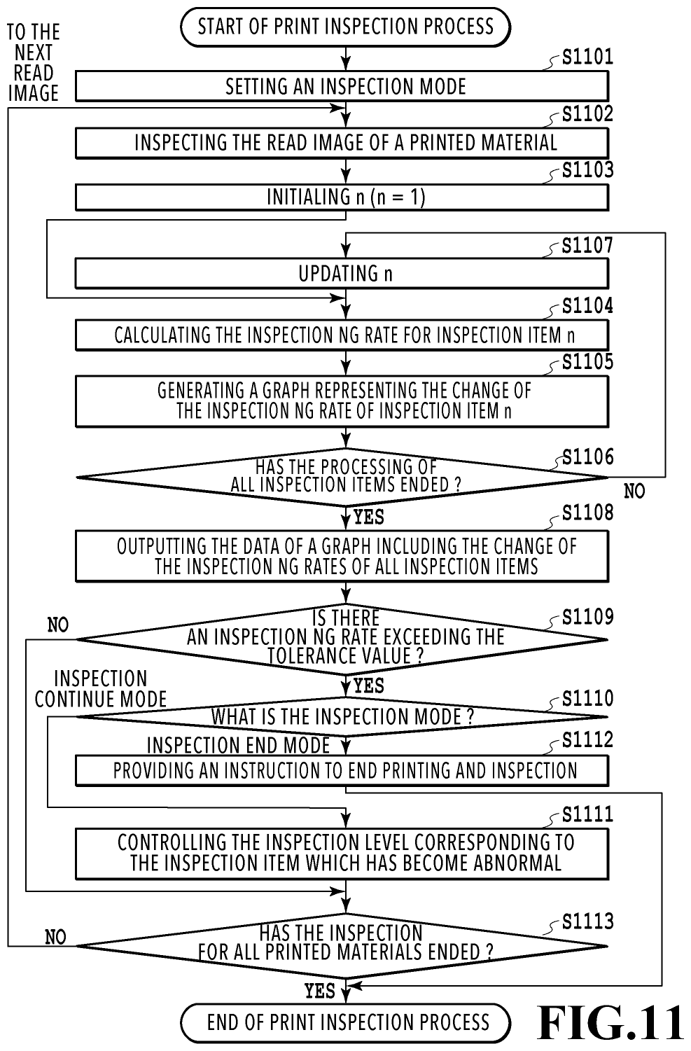

FIG. 11 is a flowchart illustrating the processing procedure of the print inspection in the present embodiment. In the present embodiment, unlike in the first embodiment, in a case where it is decided by the inspection result determining unit 305 that an abnormality has occurred, the processing is switched according to the set inspection mode.

In S1101, the inspection mode setting unit 1001 presets the inspection mode of either the inspection end mode or the inspection continue mode.

As S1102 to S1109 are the same as S801 to S808 in FIG. 8, explanations thereof are omitted.

In a case where the inspection result determining unit 305 determines in S1109 that there is an inspection item whose inspection NG rate exceeds the tolerance value (YES in S1109), the processing proceeds to S1110. In a case where there is no inspection item whose inspection NG rate exceeds the tolerance value (NO in S1109), the processing proceeds to S1113 to continue the inspection. S1113 is the same processing as S810.

In S1110, the inspection mode obtaining unit 1002 obtains the inspection mode that is set in S1101, and switches the processing according to the obtained mode. In a case where it is determined in S1110 that the set inspection mode is the “inspection continue mode,” the processing proceeds to S1111.

S1111 is the same processing as S809 in FIG. 8. That is, in S1111, the inspection control unit 306 controls the inspection level of the inspection item whose inspection NG rate exceeds the tolerance value to be relaxed. Then, the processing proceeds to S1113 to continue the inspection.

In a case where the inspection mode that is set in S1110 is determined to be the inspection end mode, the processing proceeds to S1112. In S1112, the inspection end instructing unit 1003 instructs the printing apparatus 110 to end printing, thereby ending the printing process currently being performed. Since the inspection also ends, the flowchart ends. In this way, in the present embodiment, printing and the inspection are ended in a case where the inspection end mode is set.

### [Switching of Processing According to Inspection Mode]

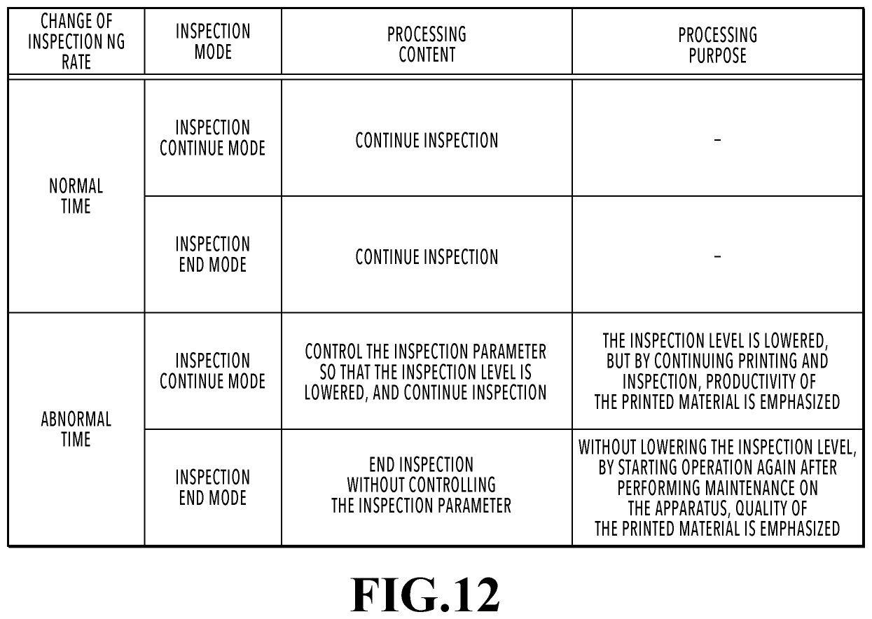

FIG. 12 is a table for explaining the switching of processing according to the inspection mode. In the present embodiment, in a case where the inspection NG rate is below the tolerance value and is normal, regardless of whether the set inspection mode is the inspection continue mode or the inspection end mode, the inspection and printing are controlled to continue.

On the other hand, in a case where the inspection NG rate exceeds the tolerance value, and in a case where the inspection continue mode is set, the inspection and printing are continued while controlling the inspection level to be more relaxed. By doing so, maintaining the productivity of printed material is possible.

Reasons why the inspection NG rate exceeds the tolerance value and is determined to be abnormal may include troubles in the printing unit or the conveying unit of the printing apparatus 110 or the reading unit (the scanner) of the reading apparatus 120 and the like. Troubles in the printing unit may include exposure, recording trouble in the latent image portion, scratches on the developing roller, and the like. Further, in a case of a printing unit that performs printing in an inkjet system, troubles of the printing unit may include defective ink ejection, a rapid increase in uneven streaks due to soil adhering to the head face plane, and the like. Troubles in the conveying unit may include continuous adhesion of soil to a member such as a roller that comes in contact with sheets and the like. Troubles in the reading unit may include adhesion of dust to the sensor, the occurrence of continuous streaks due to scratches on the glass plate, and the like.

In a case where the inspection NG rate exceeds the tolerance value, although the productivity can be maintained by relaxing the inspection level, it is conceivable that the quality of the printed material deteriorates due to these troubles. For this reason, for example, the inspection continue mode is set in a case of printed material such as an internal document, where there is no problem even if the quality is inferior.

Further, in some cases, if the inspection result changes during the inspection, ending the inspection and printing and executing maintenance of the printing apparatus 110 or the like is preferable in order to ensure the quality of the printed material. In this case, the inspection end mode is set. In a case where the inspection end mode is set and the inspection NG rate exceeds the tolerance value, the inspection and printing are ended. Therefore, the printing apparatus 110, the reading apparatus 120, etc., can be ended and then operated again after maintenance is performed. Since the inspection level is not controlled to be more relaxed in a case where the inspection end mode is set, performing an operation that emphasizes the quality of the printed material is possible.

In this way, in the present embodiment, it is possible to properly perform switching between ensuring productivity by continuing inspection with a relaxed inspection level and ending printing and the inspection to ensure the quality of printed material, rather than productivity.

According to the present disclosure, it is possible to verify change in an inspection result chronologically.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2022-193563, filed Dec. 2, 2022, which is hereby incorporated by reference wherein in its entirety.

What is claimed is:

1. An information processing apparatus comprising:
an inspecting unit configured to inspect a printed material based on a read image obtained by reading the printed material;
a management unit configured to manage first information relating to an inspection result obtained by inspection performed by the inspecting unit; and
a generating unit configured to generate data for displaying second information indicating temporal change in the inspection result based on the first information.

2. The information processing apparatus according to claim 1,
wherein the second information is a graph indicating temporal change in the inspection result.

3. The information processing apparatus according to claim 1,
wherein, in a case where there is a plurality of inspection items for the inspecting unit, the generating unit generates the data for displaying the second information for each of the inspection items.

4. The information processing apparatus according to claim 1,
wherein the second information includes a tolerance value corresponding to the inspection result for each inspection item, and the tolerance value for an inspection item related to an image quality defect is lower than the tolerance value for an inspection item not related to the image quality defect.

5. The information processing apparatus according to claim 1,
wherein the generating unit generates the data while the inspecting unit continues inspection, and
wherein the data is output every time the data is generated.

6. The information processing apparatus according to claim 5,
wherein, every time a new inspection result is obtained by the inspecting unit performing an inspection, the generating unit generates the data so as to include the new inspection result in the second information.

7. The information processing apparatus according to claim 1, further comprising
a control unit configured to control an inspection level of the inspecting unit to be changed in a case where the inspection result satisfies a predetermined condition.

8. The information processing apparatus according to claim 7,
wherein the control unit controls the inspection level of the inspecting unit to be more relaxed in a case where a value based on the inspection result exceeds a predetermined value, and
wherein the inspecting unit continues inspection with the inspection level changed by the control unit.

9. The information processing apparatus according to claim 8,
wherein the value based on the inspection result indicates any one of the number of inspections the inspecting unit has determined as inspection failed, a ratio of the number of inspections the inspecting unit has determined as inspection failed to the number of inspections, a value indicating an amount of change in the number determined as inspection failed, or an amount of change in the ratio.

10. The information processing apparatus according to claim 7,
wherein, in a case where there is a plurality of inspection items for the inspecting unit, the control unit determines whether the inspection result of each inspection item satisfies the predetermined condition, and controls the inspection level of the inspection item determined to satisfy the predetermined condition to be changed.

11. The information processing apparatus according to claim 7,
wherein the control unit controls the inspection level to be changed only for an inspection item related to an image quality defect.

12. The information processing apparatus according to claim 7, further comprising
a setting unit configured to set a first mode for ending the inspection performed by the inspecting unit or a second mode for continuing the inspection performed by the inspecting unit,
wherein, in a case where the inspection result satisfies the predetermined condition, if a mode set by the setting unit is the second mode, the control unit controls the inspection level to be changed.

13. The information processing apparatus according to claim 12,
wherein, in a case where the inspection result satisfies the predetermined condition, if the mode set by the setting unit is the first mode, the inspection level is not changed by the control unit, and the inspection performed by the inspecting unit is ended.

14. The information processing apparatus according to claim 12,
wherein, in a case where the inspection result satisfies the predetermined condition, if the mode set by the setting unit is the first mode, printing a printing unit ends the printing.

15. The information processing apparatus according to claim 1,
wherein the inspection result includes at least one of a ratio of inspections the inspecting unit has determined as inspection failed the number of inspections the inspecting unit has determined as inspection failed, a ratio of inspections the inspecting unit has determined as inspection passed, and the number of inspections the inspecting unit has determined as inspection passed.

16. An information processing method comprising:
inspecting a printed material based on a read image obtained by reading the printed material;
managing first information relating to an inspection result obtained by the inspection; and
generating data for displaying second information indicating temporal change in the inspection result based on the first information.

17. A non-transitory computer readable storage medium storing a program which causes a computer to perform an information processing method,
inspecting a printed material based on a read image obtained by reading the printed material;
managing first information relating to an inspection result obtained by the inspection; and
generating data for displaying second information indicating temporal change in the inspection result based on the first information.
